(19) United States
(12) Patent Application Publication
(10) Pub. No.: US 2005/0195762 A1
(43) Pub. Date: Sep. 8, 2005

(54) Communication system

(75) Inventors: Fabio Longoni, Malaga (ES); Kalle Ahmavaara, Helsinki (FI); Basavaraj Patil, Coppell, TX (US); Kaiser Chen, San Diego, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/929,794

(22) Filed: Aug. 31, 2004

(30) Foreign Application Priority Data
Mar. 8, 2004 (GB) 0405174.4

(51) Int. Cl. H04L 12/56

(52) U.S. Cl. 370/328

(57) ABSTRACT

A method of establishing a communication in a mobile communication system includes two steps. The mobile communication system includes a core network and at least one user equipment connected thereto via a radio access network. The method includes providing at least two types of domain for carrying a predetermined datastream for the communication in the core network. The method also includes providing one of the types of domain for carrying the predetermined datastream in the radio access network.

### BACKGROUND TO THE INVENTION

1. Field of Invention

The present invention relates to a method of establishing a communication to a user equipment, and particularly, but not exclusively, to a method of establishing voice communication.

2. Background to the Invention

Communication networks are commonplace today. Communication networks typically operate in accordance with a given standard or specification. For example, the standard or specification may define the communication protocols and/or parameters that shall be used for a connection. Examples of the different standards and/or specifications include, without limiting to these, PSTN (Public Switched Telephone Network), GSM (Global System for Mobile communications), other GSM based systems (such as GPRS: General Packet Radio Service), AMPS (American Mobile Phone System), DAMPS (Digital AMPS), WCDMA (Wideband Code Division Multiple Access) or 3rd generation (3G) UMTS (Universal Mobile Telecommunications System), IMT 2000 (International Mobile Telecommunications 2000) and so on.

In a cellular communication system a base station serves user equipment (UE) such as mobile stations via a wireless interface, which may also be referred to as an air interface. An appropriate transceiver apparatus may serve each of the cells of the cellular system. The communication from the UE to a core network may be via the air interface and a radio access network, which typically comprises a base station and a radio access network controller. The radio access network controller may be connected to and controlled by another controller facility that is typically in the core network of the communication system. An example of the core network controller is a serving GPRS support node (SGSN). The controllers may be interconnected and there may be one or more gateway nodes for connecting the cellular network to other communication networks. For example, the SGSN may be connected to a Gateway GPRS support node (GGSN) for connecting the mobile network to the Internet and/or other packet switched networks.

Communication can take place with the transmission of data between the user equipment and the radio access network during a call. An example of one type of data that may be transmitted during a call is speech or voice data. Other data types include multimedia data such as video and audio data. The communication between different user equipment may adopt one of two services: a circuit switched (CS) service or a packet switched (PS) service.

User equipment adopting a circuit switched service can communicate with each other over a transmission channel that is reserved for the entire duration of the communication. This implies that the data is transmitted over a fixed route, or fixed datastream, and that the transmission time is fixed and predictable. Typically the transmission is continuous and lasts for the duration of the entire communication. As such, a circuit switched service is ideally suited for speech or voice calls to user equipment, and has been adopted by communication systems such as PSTN and GSM. In GSM, the quality of voice calls may be further enhanced by utilising an adaptive multirate (AMR) codec.

User equipment may also adopt a packet switched service. In a packet switched service, the transmitted data is broken into sub-blocks known as data packets. Each data packet can be transmitted from source to destination independently of other data packets, and it is up to the network to route these packets from source to destination. Each data packet has a packet header, which contains information such as the source and destination addresses for the data packet. In general, a packet switched service provides only a so-called ‘best effort’ service: the data packets are transmitted from source to destination without any guarantees about the quality of service (QoS). Therefore, it is possible that some of the packets are lost during transmission, and the time required for the transmission from source to destination is generally unpredictable. Due to varying load in the network and possibly also due to different transmission paths of the packets, the transmission delay can vary from data packet to data packet within a datastream. These variations in the transmission qualities and to the QoS means that packet switched services are not generally as well suited for speech or voice calls as real-time services, such as circuit switched services, in general.

An example of a protocol operating a packet switched service is the Internet Protocol (IP). An example of a network that operates a packet switched service is a UMTS (Universal Mobile Telecommunications System) network. A UMTS network may include at its core an IP Multimedia Subsystem (IMS). The IMS is an IP based system that can handle both voice or speech data and multimedia data.

Today, GSM networks have evolved from a GSM circuit switched based core network to integrate new 3G services. One example of such a system is GSM/UMTS network, which includes a core network that combines features from both a GSM circuit switched based core network and a packet switched based UMTS core network.

In a GSM/UMTS network, circuit switched services can be provided by the GSM part of the network and routed via the GSM MSC (mobile switching centre). The MSC may be connected to traditional circuit switched networks such a PSTN or ISDN (Integrated Services Digital Network). Packet switched services may be routed via the GPRS (general packet radio service) part of the network, and specifically via a SGSN (serving GPRS support node) and a GGSN (gateway GPRS support node). The GGSN may be connected to packet switched networks such as the IMS of a UMTS system. The IMS may in turn be connected to other networks such as the Internet, a PSTN or another GSM/UMTS network.

Presently in a GSM/UMTS network voice calls from user equipment are transmitted via either the circuit switched GSM part of the network, often referred to as the circuit switched domain, or the packet switched GPRS part of the network, often referred to as the packet switched domain. The routing may be dependent on the destination of the call. For example, if the voice call terminates at a standard telephone connected to a PSTN network, then the voice call may be transmitted via the circuit switched domain via the MSC. However, if the voice call terminates at a device connected to the IMS or some other network connected to the IMS such as the Internet or the PSTN, then the voice call may be transmitted via the packet switched domain. Voice calls transmitted via the packet switched domain are commonly referred to as Voice over IP (VoIP) calls.

Voice calls over the GSM circuit switched domain may utilise GSM call control (CC) for call establishment, call clearing, call information phase and other call control procedures. For GSM voice calls, the data bearer or data path that carries the datastream for the voice call will be established via the circuit switched domain.

For VoIP calls, a Session Initiation Protocol (SIP) may be used for call control for session establishment, session release, session status and other call control related procedures. For VoIP calls, the data bearer or data path that carries the datastream for the voice call will be established via the packet switched domain.

In a GSM/UMTS network, there are problems with running two separate call control mechanisms for voice calls over a circuit switched domain and VoIP calls over a packet switched domain. The user equipment has to maintain two different protocols, or protocol stacks, for call control purposes: one for circuit switched voice calls and one for packet switched VoIP calls. Both call control mechanisms are used for similar purposes, such as call establishment/release, but with the significant difference that each mechanism is used to establish a different type of data bearer type.

Present VoIP techniques also specifically suffer various problems. Packet switched domains are not typically optimised for real time traffic, such as voice calls. Therefore, the utilisation of the air interface for VoIP calls may not be optimised in a packet switched domain. Packet switched domians are not as well suited to real time traffic, such as that of voice calls, compared to circuit switched domains. In a circuit switched domain, a dedicated channel or data bearer can be established for the duration of a voice call, and the voice data can be transmitted continuously over this data bearer. In VoIP, because the voice data needs to be sent as individual data packets, an overhead may be introduced when the voice data is transmitted over the air interface. These overheads may arise from the additional data of various data packet headers in each data packet such as RTP (real time protocol) headers, UDP (user datagram protocol) headers and IP headers. In a wired Internet network, such overheads may be acceptable due to the low costs of transmitting data. However, in a wireless system, such overheads may not be acceptable as the resource of the radio spectrum of the air interface is very valuable and efficiency is paramount.

### SUMMARY OF THE INVENTION

It is the aim of embodiments of the present invention to address one or more of the above-stated problems.

According to the invention there is provided a method of establishing a communication in a mobile communication system comprising a core network and at least one user equipment connected thereto via a radio access network, the method comprising providing at least two types of domain for carrying a predetermined datastream for the communication in the core network, and providing one of said types of domain for carrying the predetermined datastream in the radio access network.

The method is adapted such that the predetermined datastream is carried on the one type of domain in the radio access network irrespective of the domain on which it is carried in the core network.

The communication may be a voice call and the predetermined datastream may comprise voice data. The at least two type of domains may include a packet switched domain and a circuit switched domain, wherein the circuit switched domain is provided in the radio access network.

The user equipment may be connected to the radio access network via an air interface, and the circuit switched domain provided in the radio access network may also provided over the air interface.

The voice call may be established using first and second call establishment methods for each of the packet and circuit switched domains. The first call establishment method for the packet switched domain may be a SIP based method. The SIP based method may be used to establish a PDP context. The PDP context may be initiated between a control element of the packet switched domain and a gateway element of the circuit switched domain. The PDP context may be initiated in the packet switched domain after an initial PDP context establishment for the voice call.

The gateway element may establish a data bearer for the voice call.

A second call establishment method for the circuit switched domain may be a circuit switched call control method.

The gateway element may be a circuit switched media gateway.

The voice call may be established using a single call establishment method for each of the packet and circuit switched domains. The call establishment method may be a circuit switched call control method.

The voice data may be carried in the circuit switched domain in the core network. The voice call may be established using a single call establishment method for each of the packet and circuit switched domains. The call establishment method may be a SIP based method.

The voice data may be carried in a circuit switched datastream over the radio access network and the core network. If the datastream for the voice data terminates at a packet switch enabled device, an interface may be provided to the core network to convert the circuit switched datastream. The circuit switched datastream may pass through a gateway element. The gateway element is a circuit switched media gateway.

The user equipment may be a mobile terminal.

In a further aspect the invention provides a mobile communication system comprising a core network and at least one user equipment connected thereto via a radio access network, the mobile communication system comprising means for providing at least two types of domain adapted for carrying a predetermined datastream for a communication in the core network, and means for providing one of said types of domain for carrying the predetermined datastream in the radio access network.

The means for providing one of said types of domain for carrying the predetermined datastream in the radio access network may be adapted to direct the predetermined data stream to one domain in the radio access network irrespective of the domain in which the datastream is carried in the core network.

The core network may be adapted to detect the predetermined data stream on either of the two domains, and responsive thereto to direct the datastream only to the one domain in the radio access network.

The communication may be a voice call and/or the predetermined datastream may comprise voice data.

The at least two type of domains may include a packet switched domain and a circuit switched domain, and the circuit switched domain may be provided in the radio access network.

The user equipment may be connected to the radio access network via an air interface, and the circuit switched domain provided in the radio access network may be also provided over the air interface.

The mobile communication system may further comprise means for establishing the voice call using first and second call establishment methods for each of the packet and circuit switched domains.

The mobile communication system may further comprise means for establishing the voice call using a single call establishment method for each of the packet and circuit switched domains.

The mobile communication system may further comprise means for carrying the voice data in the circuit switched domain in the core network.

The mobile communication system may further comprise means for establishing the voice call using a single call establishment method for each of the packet and circuit switched domains.

In a further aspect the invention provides a mobile communication system comprising a core network and at least one user equipment connected thereto via a radio access network, the mobile communication system comprising each of a packet switched domain and a circuit switched domain in the core network, wherein each of said packet switched and circuit switched domain are adapted to carry a predetermined datastream for a communication in the core network, wherein the predetermined datastream is carried only in the circuit switched domain in the radio access network. The predetermined datastream is preferably a voice datastream. As such, voice data transmitted in the packet switched domain in the core network is transmitted in the circuit switched domain in the radio access network.

In a further aspect the invention provides a network element for a mobile communication system, wherein said mobile communication system comprises a core network and at least one user equipment connected thereto via a radio access network and at least a packet switched domain and a circuit switched domain for carrying a predetermined datastream for a voice call in the core network, said network element adapted for providing the circuit switched domain for carrying the predetermined datastream in the radio access network.

In a further aspect the invention provides a network element for a mobile communication system, wherein said mobile communication system comprises a core network and at least one user equipment connected thereto via a radio access network, and at least a packet switched domain and a circuit switched domain for carrying a predetermined datastream for a voice call in the core network, said network element being adapted to route the predetermined datastream in the packet switched domain in the core network to the circuit switched domain in the radio access network.

Said network element is preferably controlled responsive to a packet data protocol request as defined hereinafter.

A first exemplary embodiment is described herein, in which a VoIP voice call is preferably routed in a core network of a mobile communication system in the packet switched domain, and preferably routed in the radio access network and/or the air interface between the core network and a user equipment in the circuit switched domain. The radio access network, and the air interface, are thus preferably configured with circuit switched data bearers. The VoIP voice call is preferably terminated at an IP enabled terminal connected to an external network accessed through the core network.

The establishment of the call is preferably achieved using a PDP context set up using SIP for call control. This first embodiment thus ensures that the call is always routed in the circuit switched domain in the radio access network, and therefore the air interface, regardless of whether the call is handled in the circuit switched or packet switched domain in the core network.

In this first embodiment, there is no specific requirement for how the set-up of circuit switched calls may be configured. Circuit switched calls may be set up using conventional circuit switched call-control mechanisms.

Thus the first embodiment preferably provides for an arrangement in which calls are always routed in the circuit switched domain in the air interface, but packet switched calls may be established using a PDP context set up using a SIP session, and circuit switched calls may be set-up using conventional circuit switched call control methods. Preferably certain types of calls, such as voice calls, are routed in this way.

Thus, in accordance with a first embodiment of the invention, there is generally provided a method of establishing a communication in a mobile communication system comprising a core network and at least one user equipment connected thereto via a radio access network, the method comprising providing at least two types of domain for carrying a predetermined datastream for the communication in the core network, and providing one of said types of domain for carrying the predetermined datastream in the radio access network.

Preferably, the communication is a voice call and the predetermined datastream comprises voice data.

The at least two type of domains may include a packet switched domain and a circuit switched domain, wherein the circuit switched domain is provided in the radio access network. The user equipment may be connected to the radio access network via an air interface, and the circuit switched interface provided in the radio access network may also be provided over the air interface.

Preferably, the voice call is established using first and second call establishment methods for each of the packet and circuit switched domains.

The first call establishment method for the packet switched domain may be a SIP based method. The SIP based method may also be used to establish a PDP context.

The PDP context may be initiated between a control element of the packet switched domain and a gateway element of the circuit switched domain. Preferably the PDP context is initiated in the packet switched domain after an initial PDP context establishment for the voice call.

The gateway element may establish a data bearer for the voice call.

The second call establishment method for the circuit switched domain may be a circuit switched call control method.

The gateway element may be a circuit switched media gateway.

The first embodiment may provide, in an alternative arrangement, a method of routing a communication in a communication network, the communication network having at least two transport mechanisms for transferring a data stream to a terminal, wherein the data stream is routed through the network in dependence on the first transport mechanism, and selectively routed to the terminal on the second transport mechanism.

The alternative arrangement of the embodiment preferably provides a gateway between the network and the terminal, said gateway transferring the data stream fro one transport mechanism to the other.

The alternative arrangement of the embodiment preferably comprises a mobile communication system, in which the network comprises a mobile communication system having a packet switched domain supporting the first transport mechanism and a circuit switched domain supporting the second transport mechanism, and an air interface between the network and the terminal, the data stream being transported in the packet switched domain within the network, and being carried in a circuit switched transport mechanism in the air interface. The gateway is preferably an interface between the packet switched domain and the circuit switched domain.

The data stream may preferably consist of voice data. The voice data may be transported as Voice over IP in the packet switched domain, and AMR speech in the circuit switched domain. The voce data may be transported as AMR speech in the Voice over IP packets. The communication between the network and the terminal is preferably established by way of a PDP context between the terminal and the network or a further network environment connected to the network, such as an IP environment.

The selective routing is preferably responsive to an additional PDP context established between the terminal and a control element supporting the first transport mechanism. Such control element preferably communicates with the gateway.

In the alternative arrangement of the first embodiment, the control of the selective routing is preferably by use of a SIP session, and specifically a PDP context.

In the first embodiment of the invention there is preferably also provided a packet data protocol (PDP) context for establishing a circuit switched connection between a user equipment and a network element. The user equipment may be any device for connection in to a communication network, for example a mobile terminal. The network element may be an access network element such as an element of a radio access network. The network element may be a core network element. A core network element may be a gateway element. The packet data protocol context may be used to control a gateway element in the core network. The gateway element may be controlled to terminate packet switched communications directed toward the user equipment, and to terminate circuit switched communications directed toward the core network. The gateway element may provide an interface between a packet switched domain in the core network and a circuit switched domain in the access network. The packet data protocol may configure the gateway element. The packet data protocol may be initiated by the user equipment or the core network.

A second embodiment differs from the first embodiment, in that control of the selective routing may preferably be by use of circuit switched call control as defined for circuit switched speech.

As in the first embodiment, for the second embodiment there is ensured that the call is always routed in the circuit switched domain over the air interface, regardless of whether the call is handled in the circuit switched or packet switched domain in the core network.

The second embodiment offers an advantage over the first embodiment, in that the calls are preferably set-up using a single technique. Specifically regardless of whether the calls are packet switched or circuit switched, a circuit switched call control technique as defined for circuit switched speech is preferably used for call set-up, and the calls are preferably all transmitted in the air interface in the circuit switched domain.

In an alternative arrangement of the second embodiment there is provided a method of routing a communication in a communication network, the communication network having at least two transport mechanisms for transferring a data stream to a terminal, wherein the data stream is routed through the network in dependence on the first transport mechanism, and selectively routed to the terminal on the second transport mechanism.

A third exemplary embodiment is described herein, in which a VoIP call is preferably routed in a core network of a mobile communication system, in the circuit switched domain, and preferably routed in the radio access network and over the air interface between the core network and a user equipment in the circuit switched domain. The radio access network and air interface are thus preferably configured with circuit switched data bearers. The VoIP voice call is preferably terminated at an IP enabled terminal connected to an external network accessed through the core network, and conversion may be required at the interface of that external network to the IP enabled terminal.

The establishment of the call is preferably achieved using SIP for call control. This third embodiment thus preferably ensures that the call is always routed in the circuit switched domain in the air interface and in the core network, regardless of whether the call is a VoIP call or a circuit switched call.

The third embodiment further preferably establishes the circuit switched call using a PDP context of an SIP. Thus calls may be established in the circuit switched domain using SIP for call control.

A characteristic of each embodiment described herein is that, where a voice call is established, it is established in the radio access network and/or over the air interface between the core network and the user equipment using a circuit switched connection. Thus, all voice calls are preferably established in the circuit switched domain in the air interface, even if they are VoIP calls. More generally, for a given datastream, the datastream is carried in the radio access network and/or over the air interface by a predetermined domain, regardless of the domain carrying the datastream in the core network.

Preferably the control method that establishes the connection in the domain over the air interface is the same regardless of the domain used the core network.

The connection in the core network may further always be a circuit switched connection, regardless of whether the call terminates with a VoIP enabled terminal.

### BRIEF DESCRIPTION OF THE DRAWINGS

For a better understanding of the present invention reference will now be made by way of example only to the accompanying drawings, in which:

FIG. 1 illustrates a communication system in which embodiments of the present invention can be applied;

FIG. 2 illustrates an arrangement of the prior art;

FIG. 3 illustrates a communications system in a first embodiment of the invention;

FIG. 4 illustrates a flow chart in the first embodiment of the invention;

FIG. 5 illustrates a message flow diagram in a second embodiment of the invention;

FIG. 6 illustrates a further message flow diagram in a second embodiment of the invention;

FIG. 7 illustrates a communications system in a third embodiment of the invention; and

FIG. 8 is a message flow diagram for the third embodiment of the invention.

### DESCRIPTION OF THE PREFERRED EMBODIMENTS

The present invention is described herein with reference to particular examples. The invention is not, however, limited to such examples. In particular the invention is described by way of reference to an exemplary GSM/UMTS network.

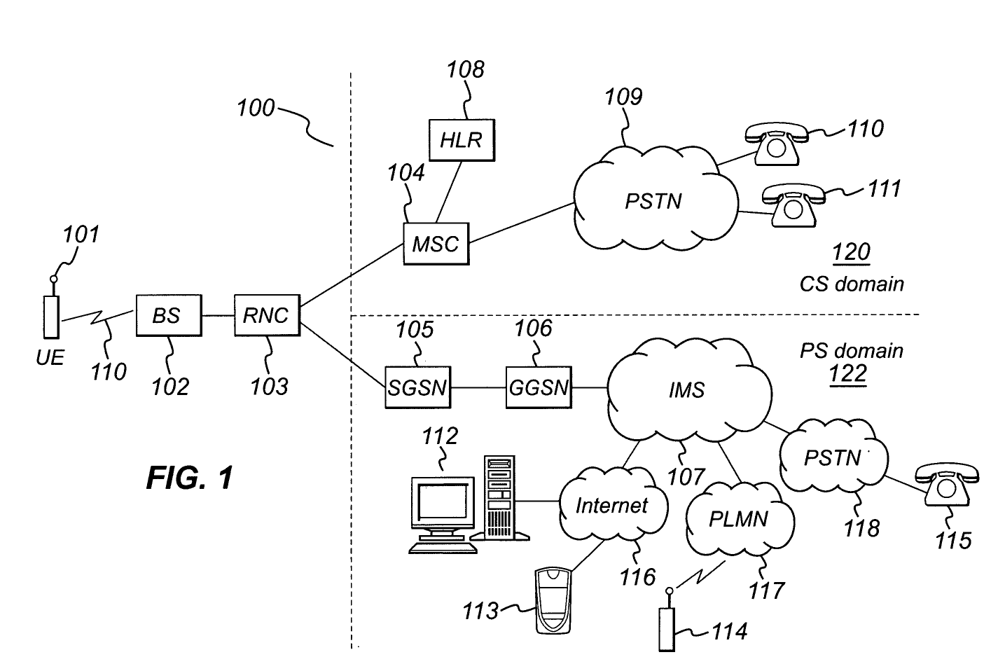

FIG. 1 illustrates an exemplary known GSM/UMTS network 100 that supports both circuit switched and packet switched services. The network 100 comprises various network elements including a base station (BS) 102. The BS may communicate with user equipment (UE) 101 over an air interface 110. Examples of UEs include mobile terminals, personal digital assistants (PDAs) and other suitably configured devices. The BS 102 is further connected to a radio network controller (RNC) 103. The BS 102 and RNC 103 are generally referred to as a radio access network (RAN). The RNC is connected to other network elements, including a mobile switching centre (MSC) 104 and a serving GPRS support node (SGSN) 105. The MSC 104 is connected to a home location register (HLR) 108. The SGSN is connected to a gateway GPRS support node (GGSN) 106. The elements of the BS 102, RNC 103, MSC 104, HLR 108, SGSN 105 and GGSN 106 together comprise a GSM UMTS public land mobile network (PLMN).

The MSC 104 may communicate with external networks such as a public switched telephone network (PSTN) 109. The GGSN 106 may communicate with external packet data networks such as an IMS network 107. The MSC 104, HLR 108 and PSTN 109 form part of a circuit switched (CS) domain 120. The SGSN 105, GGSN 106 and IMS 107 form part of a packet switched (PS) domain 122.

The PSTN 109 may further connect to standard telephones 110 and 111. The IMS may further connect to other networks such as the Internet 116, another PLMN 117 and a PSTN 118. User equipment connected to each of these networks are able to communicate with the IMS. The user equipment may include a personal computer 112 and a SIP enabled device 113 connected to the Internet 116, a mobile terminal 114 connected to the PLMN 117, and a standard telephone 115 connected to the PSTN 118.

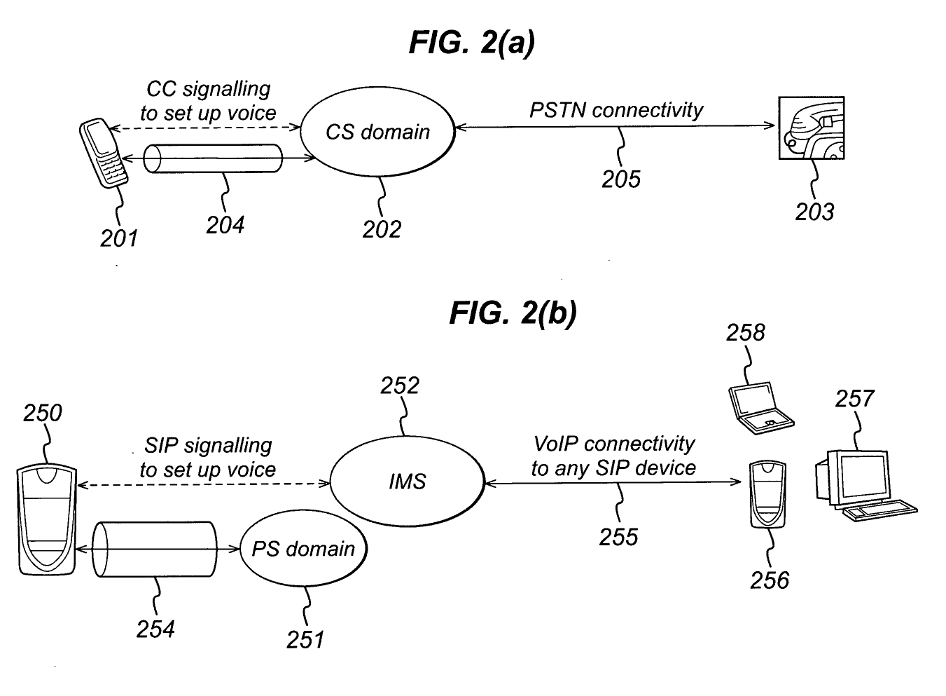

Reference is now made to FIG. 2, which illustrates examples of known arrangements for a voice, or speech, call in the network of FIG. 1.

FIG. 2(a) illustrates a voice call between a UE 201, such as a mobile terminal, and a fixed line telephone 203. The telephone 203 is connected to a

CS domain 202 via a PSTN connection 205. The UE 201 uses CS call control (CC) to establish a voice call between the UE 201 and the telephone 203 via the CS domain 202 and the PSTN connection 205. The CS domain 202 may include all the elements of the CS domain 120 described in FIG. 1 and may further include a RAN. Communications between the UE 201 and the CS domain 202 takes place over a user plane, 204, defined in the air interface.

FIG. 2(b) illustrates a voice call between a UE 250, such as a mobile terminal, and a Session Initiation Protocol (SIP) enabled device, such as a mobile terminal 256, a desktop computer 257 or a laptop 258. The SIP enabled device is connected to an IMS 252 via a PS connection such as may be provided by the Internet, which provides VoIP connectivity. The IMS 252 is connected to a PS domain 251. The UE uses SIP based signalling to establish a voice call between the UE 250 and the SIP enabled device 256, 257 or 258. This voice call between the IMS 252 and the SIP enabled device 256, 257, 258 may be in the form of a VoIP datastream. The PS domain 251 may include all the elements of the PS domain 122 described in FIG. 1 and may further include a RAN. Communications between the UE 250 and the PS domain 251 takes place over the user plane 254 defined in the air interface.

The datastream for a voice call over the user plane 254 between the UE 250 and the PS domain 251 for a VoIP call as shown in FIG. 2(b) may be larger than the datastream over the user plane 204 between the UE 201 and the CS domain 202 for a circuit switched voice call as shown in FIG. 2(a). This is partly due to the overhead of transmitting data packet headers that are present in data packets transmitted in a PS domain, especially over the air interface.

Furthermore, in FIG. 2(a) CS call control is used to establish a voice call, whereas in FIG. 2(b), SIP based signalling is used to establish a voice call.

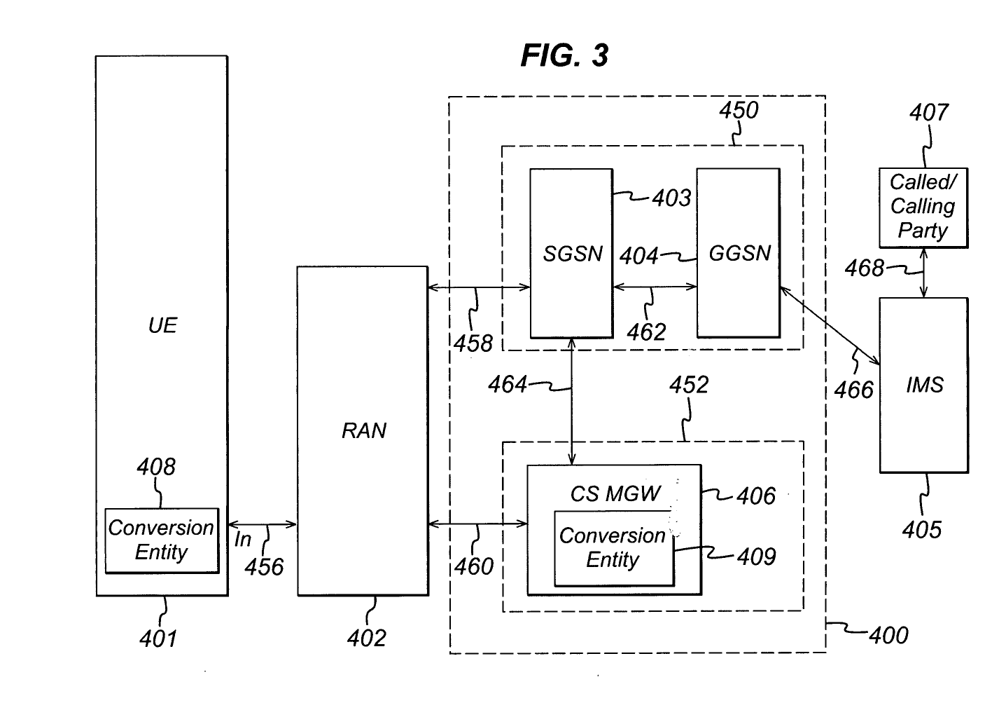

Reference is now made to FIG. 3, which illustrates the establishment of a voice call in a first embodiment of the invention. FIG. 3 illustrates a user equipment (UE) 401, which establishes a call with a calling or called party 407. A radio access network (RAN) 402 connects the UE 401 and a core network 400. A packet switched domain 450 of the core network 400 includes a serving GPRS support node (SGSN) 403 and a gateway GPRS support node (GGSN) 404. A circuit switched domain 452 of the core network 400 includes a circuit switched media gateway (CS MGW) 406. An IP multimedia sub system (IMS) 405 is connected to the packet switched domain 450 of the core network 400. The called/calling party 407 is connected to the IMS 405. Each of the UE 401 and the CS MGW 452 include associated conversion entities 408 and 409 respectively.

Only those elements of the core network 400 for understanding the described embodiment of the present invention are illustrated in FIG. 3. The RAN 402 and the CS MGW 406 may be considered to form part of the circuit switched infrastructure of the network.

Referring further to FIG. 3, the UE communicates with the RAN 402 via communication link 456 over the Uu air interface. The RAN 402 communicates with the SGSN 403 via communication link 458, and communicates with the CS MGW 406 via communication link 460. The SGSN 403 communicates via communication link 462 with the GGSN 404. The SGSN 403 communicates via communication link 464 with the CS MGW 406. The GGSN 404 communicates with the IMS 405 via communication link 466. The IMS 405 communicates via communication link 468 with the called or calling party 407.

The IMS 405 may communicate with the called/calling party 407 over a PSTN network if it is a fixed line telephone, or over a packet switched based network if it is an appropriately enabled device.

The UE may establish a voice call with the called or calling party 407, being either a telephone or a mobile terminal using SIP based signalling between the UE and the IMS in accordance with this embodiment of the invention.

If the voice call is to a telephone (a circuit switched destination), then the call may be transmitted through a PSTN network. If the call is to a SIP enabled device (a packet switched destination), then the call may be transmitted through a PS network. In both cases, this embodiment of the invention enables the use of SIP based signalling to establish the voice call.

In the following description of FIG. 3, it should be understood that the signalling and communications may occur in either direction between the UE 401 and the called or calling party 407.

If the called or calling party 407 is a packet switched device, such as a SIP enabled device, then the call may be a VoIP call, and the datastream carrying the voice data between the packet switched domain 450 and the party 407 is a VoIP datastream.

However, in accordance with this embodiment of the invention, the VoIP datastream is terminated at a media gateway in the circuit switched domain. The VoIP datastream is converted at the media gateway to a circuit switched datastream carrying the voice data of the call.

The circuit switched datastream may be AMR (adaptive multirate) coded speech. The circuit switched datastream is transmitted over the RAN 403 and the air interface to the UE 401. The UE 401 may then convert the circuit switched datastream back to the audio of the original voice data. Alternatively, the UE 401 may convert the circuit switched datastream to a packet switched datastream if, for example, the UE 401 is itself a SIP enabled device adapted to operate with packet data.

In this embodiment of the present invention, a new type of packet data protocol (PDP) context is established in the packet switched domain. The term ‘PDP context’ typically refers to the part of the data connection or data bearer that passes through the packet switched domain, for example the GPRS part of the UMTS network. The PDP context or data bearer can be seen as a logical connection or “pipe” from the UE to a gateway node, such as the GGSN. The new PDP context may be labelled “AMR Speech”, “Non Transparent IP Multimedia Stream” or any other suitable label.

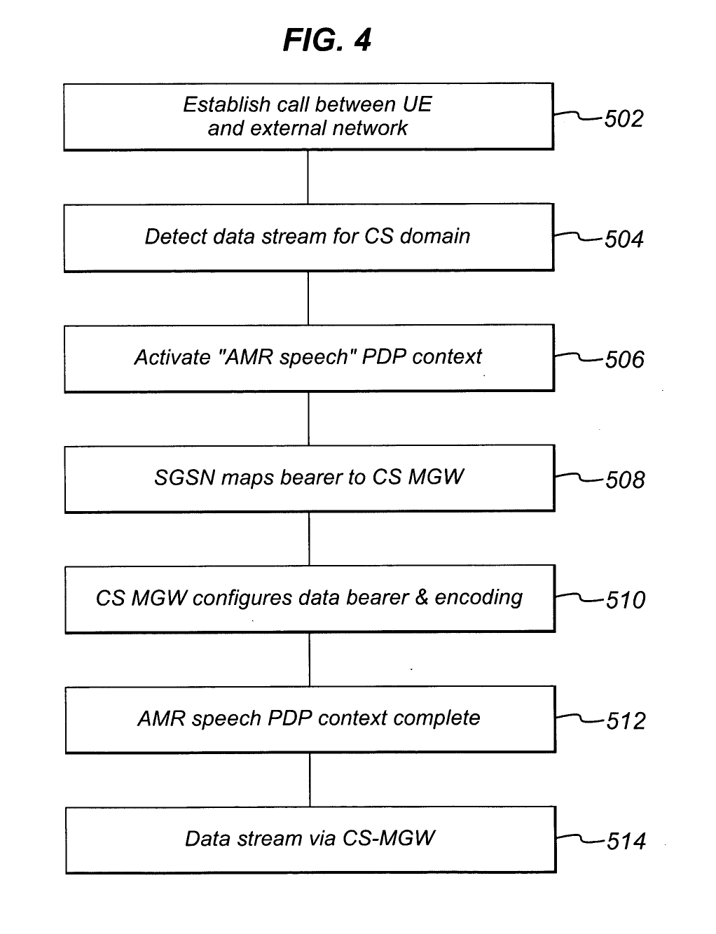

This embodiment of the invention is now described in detail, with reference to FIG. 3 and the flow chart of FIG. 4.

For the purposes of the described embodiment, it is assumed that a VoIP call is established between the UE 401 and the IMS 405 (an external network), to support a voice call between the UE 401 and the called/calling party 407. The call may be initiated by either the UE 401 or the called/calling party 407. This is represented by step 502 in FIG. 4. It is assumed that existing and established principles are used to establish the call, and the connection set-up logic is exactly as for normal VoIP calls.

On establishing this call, it is detected that at least one of the data streams to be established may be realised in the circuit switched domain over the air interface. This is represented by step 504 in FIG. 4. More particularly, in this embodiment, it is determined that at least one of the datastreams is a voice datastream which may be realised as “AMR speech”. More generally, the data stream may be realised as a “non-transparent IP multimedia stream” rather than as a transparent IP stream between the UE 401 and the network 400. This requires agreement between the UE 401 and the IMS 405 that at least one datastream will terminate in the CS MGW 406, and be established as a non-transparent datastream. The notification to the CS MGW 406 may be made by either the UE 401 or the IMS 405.

In the described preferred embodiment, the UE 401 detects the characteristic of the datastream. The UE, after authorising such with the IMS 405, then activates a new type of PDP context toward the SGSN 403, being referred to herein (by way of example only) as the “AMR speech PDP context”. This is represented by step 506 in FIG. 4. The SGSN 403 then detects, responsive to the AMR speech PDP context, that an “AMR speech”-type of data bearer is required toward the UE 401.

The SGSN 403 maps the required data bearer to the CS MGW 406, and determines that the CS MGW 406 offers a gateway to such data bearer. This is represented by step 508 in FIG. 4. The SGSN 403 then signals to the CS MGW 406, and requests the desired data bearer information and user plane parameters from the CS MGW 406.

The CS MGW 406 allocates the necessary transcoding functions, and allocates the data bearer mapping in the RAN toward the Iu interface 456. The CS MGW 406 prepares the mapping to the IP datastream to and from the external IMS network 405, and provides the selected parameters, i.e. the user plane parameters, to the SGSN 403. This is represented by step 510 in FIG. 4.

The mapping of the IP datastream in the CS MGW 406 requires mapping of VoIP data to AMR speech toward the UE 401, and mapping of AMR speech to VoIP data toward the IMS 405.

The SGSN thus establishes a circuit switched data bearer over the RAN 402 and Uu air interface, via the CS MGW 406, toward the UE 401. The circuit switched data bearer over the RAN and air interface may also be referred to as a circuit switched radio access bearer. Generally, the term radio access bearer refers to a data bearer established over the air interface for voice calls. The establishment of this circuit switched data bearer completes the AMR speech PDP context as represented by step 512 in FIG. 4. The circuit switched data bearer may utilise a circuit switched service over the Iu air interface and any AMR specific procedures such as time alignment and dynamic codec selection. It should be noted that this embodiment is directed to an example where an AMR datastream is directed towards and carried in an appropriate data bearer. More generally, any specific datastream may be directed toward an appropriate bearer in dependence on the type of datastream.

After establishment of the AMR speech PDP context in FIG. 3, an IP datastream from the called/calling party 407 is directed to the CS MGW 406, by SIP signalling between the SGSN 403 and the external IMS network 405. The CS MGW 406 terminates the IP datastream, and utilising the conversion entity 409 converts the IP datastream to an encoded datastream suitable for the data bearer established toward the UE on the Iu interface 456. In the present embodiment, this conversion is to a circuit switched datastream of AMR speech.

The UE 401 may utilise the conversion entity 408 to re-converts the encoded AMR speech, or may use the AMR speech directly.

The same principles work, in reverse, for communications from the UE 401 to the called/calling party 407. The transmission of the datastream to and from the UE 401 in this way is represented by step 514 in FIG. 4.

The conversion that takes place at the UE 401 may be dependent on the terminal type of the user equipment, or the data format required by the user. For a standard voice call, the conversion will typically be back to audio data, which may be based on standard speech decoding techniques.

Thus, this embodiment of the invention enables a communication in the network to be transmitted over the air interface on the most appropriate data bearer for the type of data of the communication. Specifically, data is routed in the packet switched domain in the core network and is routed in a circuit switched domain in the RAN and over the air interface, where conversion between the packet switched domain and circuit switched domain is through a circuit switched media gateway.

The first embodiment, illustrated with reference to FIGS. 3 and 4, preferably establishes a voice call in the circuit switched domain over the RAN and air interface, where the call is established using a PDP context set up using SIP (session initiation protocol) for call control. This differs from the prior art, where the establishment of a call using a PDP context results in the voice call being established in the packet switched domain over the air interface.

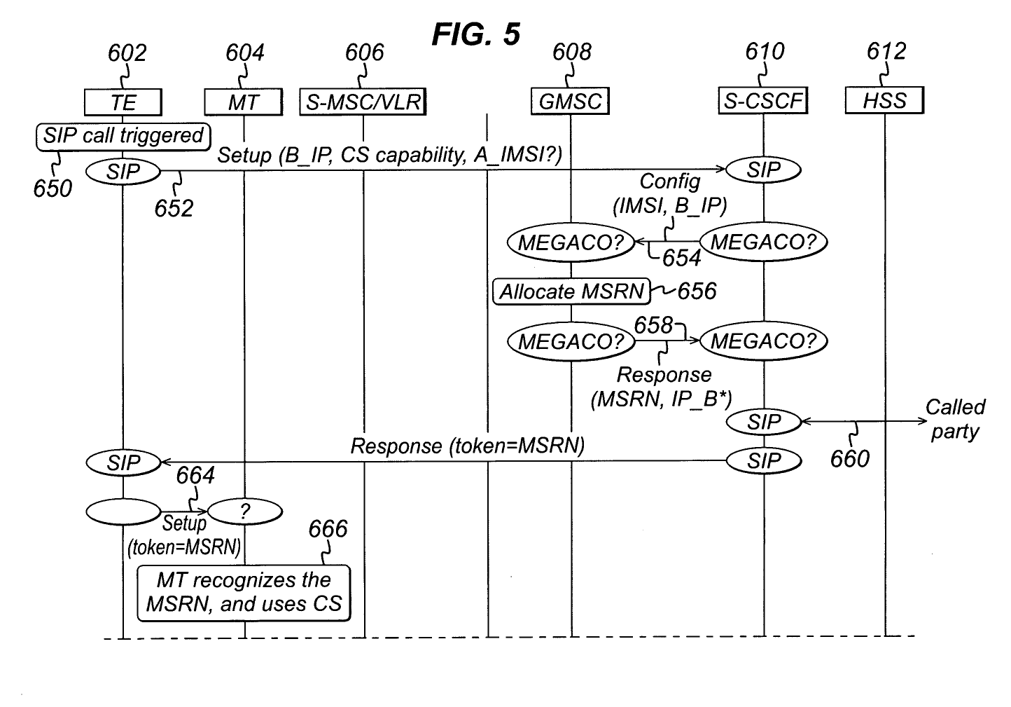

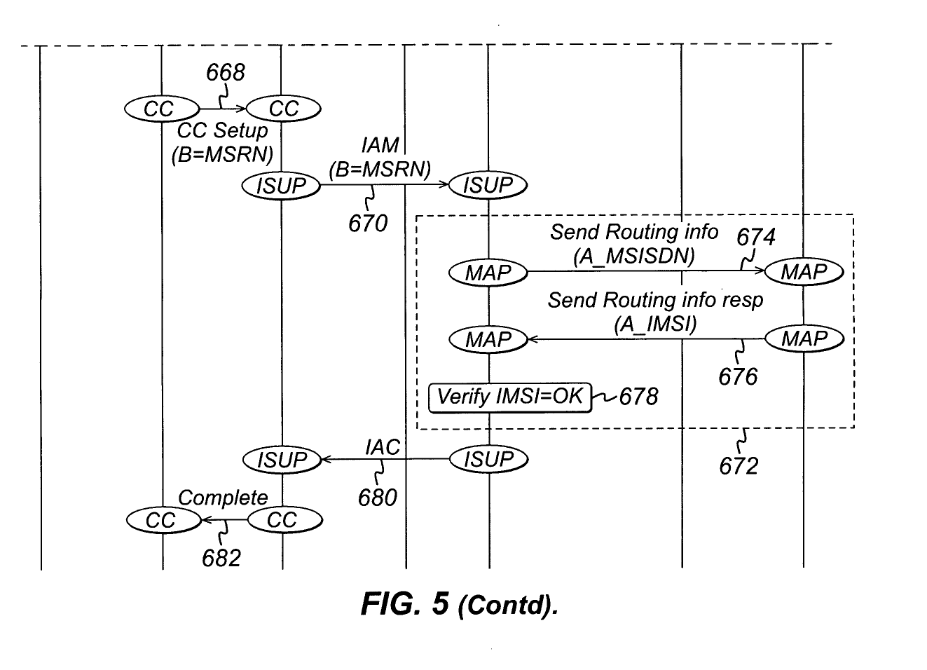

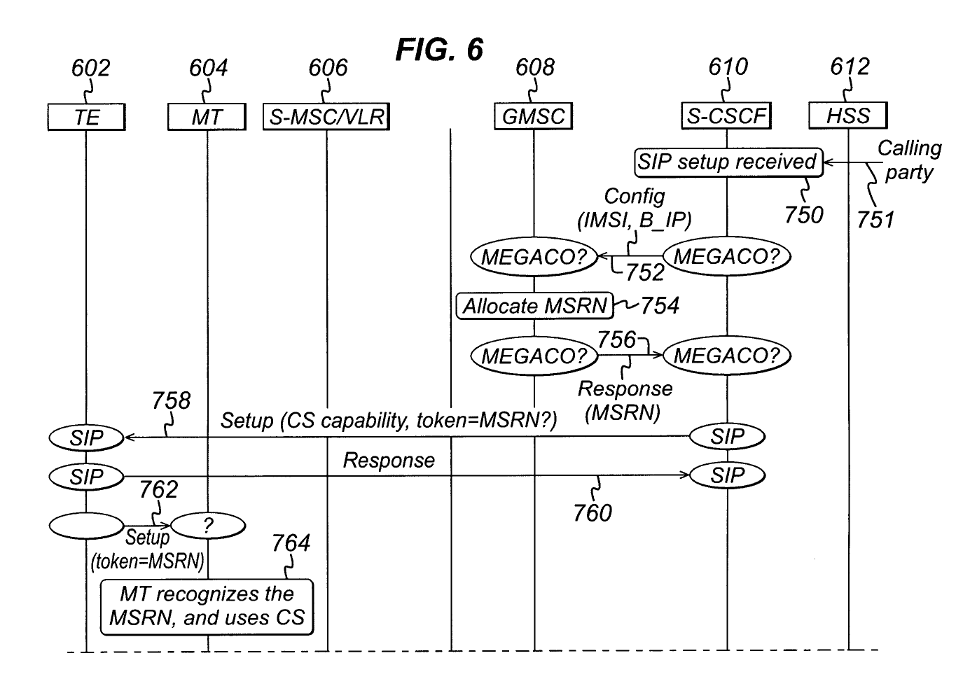

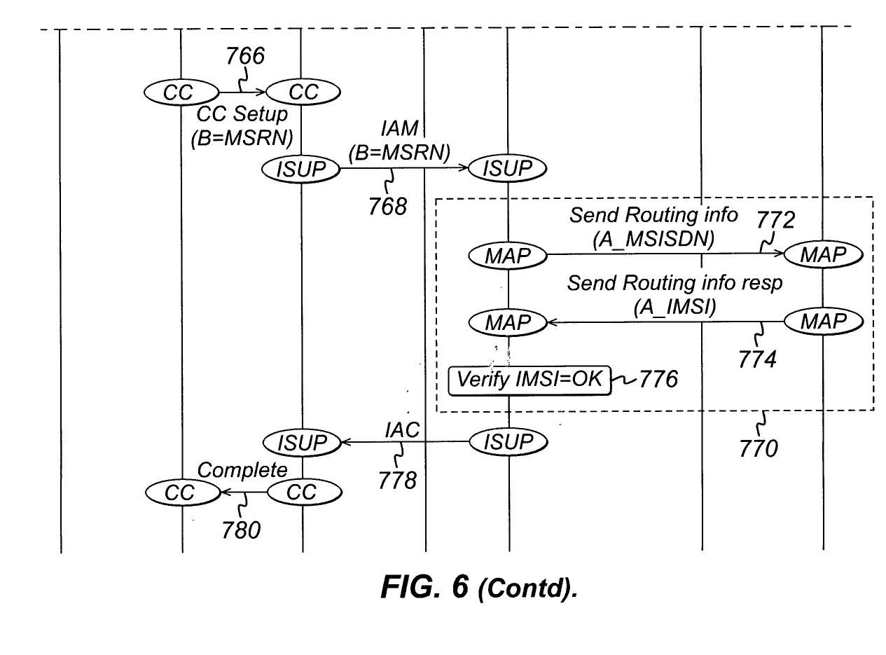

Reference is now made to FIGS. 5 and 6, which illustrate the establishment of a voice call in a second embodiment of the invention.

In this embodiment, the existing circuit switched call control (CC) signalling known in the art is reused to establish the user plane over the air interface between the UE and the CS MGW where the call is established in the core network in the packet switched domain.

In this second embodiment, there is no requirement for the new type of PDP context described in the first embodiment, as it reuses the existing infrastructure and signalling of the GSM/UMTS network. This embodiment utilises the existing circuit switched call control as defined for circuit switched speech.

FIG. 5 illustrates the second embodiment in the example scenario where the user equipment originates the call. FIG. 6 illustrates the second embodiment in the example where the user equipment receives, or terminates, the call.

FIG. 5 illustrates a message flow diagram in the second embodiment of the invention. The message flow is between the network elements of a terminal equipment (TE) 602, a mobile terminal (MT) 604, a serving mobile switching centre coupled to a visitor location centre (S-MSC/VLR) 606, a gateway mobile switching centre (GMSC) 608, a serving call sate control function (S-CSCF) 610, and a home subscriber server (HSS).

The TE 602 and MT 604 together comprise a user equipment. The TE 602 is a user plane entity and the MT 604 is a control plane entity.

The S-MSC/VLR 606, the GMSC 608, the S-CSCF 610 and HSS 612 all form part of the core network. The S-CSCF 610 may be located in an IMS and form part of a packet switched domain.

Only those network elements necessary for the understanding of the present embodiment are illustrated in FIG. 5. A person skilled in the art will appreciate that other network elements may be present that are not illustrated in FIG. 5.

The user equipment comprising TE 602 and MT 604 attempts to establish a voice call to a called party (not illustrated). The TE triggers a call using SIP, denoted by block 650. A SIP setup message “Setup” is transmitted from the TE 602 to the S-CSCF 610. The SIP message contains information on the circuit switched capabilities of the TE 602 (denoted CS capability), the IP address of the called party, denoted B_IP, and the international mobile subscriber identity (IMSI) of the TE 602, denoted A_IMSI?.

The S-CSCF 610 then sends a MEGACO configuration message “Config” 654 to the GMSC 608. The MEGACO message contains the IMSI and the B_IP transmitted by the TE 602. The GMSC 608 allocates a mobile station roaming number (MSRN) 656 as denoted by block 565, and sends a MEGACO response “Response” message 658 back to the S-CSCF 610. The MEGACO response message 658 contains MSRN and B_IP.

The S-CSCF 610 then sends a SIP message 660 towards the called party connected via a packet switched network to the S-CSCF 610. The S-CSCF 610 also sends a SIP response message “Response” 662 back to the TE 602. The SIP response message “Response” 662 contains a token corresponding to the MSRN (denoted token=MSRN).

The TE 602 sends a setup message “Setup” 664 to the MT 604, which includes the token indicating the MSRN.

The MT 604 recognizes the MSRN, as denoted by block 606, and initiates circuit switched call control. The MT 604 uses circuit switched call control to set up the call by sending a call control setup message “CC Setup” 668 to the S-MSC/VLR 606 containing information relating to the MSRN (denoted B=MSRN).

The S-MSC/VLR 606 sends an ISUP initial address message (IAM) 670 to the GMSC 608. The ISUP IAM message 670 contains the information relating to the MSRN (denoted B=MSRN). Then messaging 672 takes place between the GMSC 608 and the HSS 612, exchanging routing information and to verify the TE.

The GMSC 608 sends a routing information message “Send Routing Info” 674 comprising the mobile subscriber ISDN number for the TE 602 (denoted A_MSISDN) to the HSS 612. The HSS sends a routing information response message “send Routing Info Resp” 676 comprising the IMSI of the TE 602 (denoted A_IMSI).

The GMSC 608 can then verify, as denoted by block 678, the IMSI received from the TE 602 with that received from the HSS to verify the TE 602. The GMSC then sends an ISUP inquiry access code (IAC) message 680 to the S-MSC/VLR 606.

Once this message is received, call establishment is complete, and the S-MSC/VLR 606 sends a call establishment complete message “Complete” 682 using circuit switched call control to the MT 604.

Reference is now made to FIG. 6 where a calling party attempts to establish a voice call with a user equipment. Note that references for like elements in FIG. 5 are used in FIG. 6.

A calling party (not illustrated) sends a SIP setup message 751 to the S-CSCF 610.

The S-CSCF 610 receives this message 750, as denoted by block 759, and sends a MEGACO configuration message “Config” 752 to the GMSC 608. The MEGACO message 752 contains the IP address of the calling party (B_IP) and the international mobile subscriber identity (IMSI) of the calling party. The GMSC 608 allocates a mobile station roaming number (MSRN), as denoted by block 754, and sends a MEGACO response message “Response” 756 back to the S-CSCF 610. The MEGACO response message 756 contains the MSRN identity. The S-CSCF 610 then sends a SIP setup message “Setup” 758 towards the TE 602. The SIP setup message 758 contains a CS capability field and a token=MSRN? field.

The TE 602 sends a SIP response message “Response” 760 back to the S-CSCF 610, and also a setup message “Setup” 762 to the MT 604, which includes the token indicating the MSRN (token=MSRN).

The MT 604 recognizes the MSRN and initiates circuit switched call control 764, as denoted by block 764. The MT 604 uses circuit switched call control to set up the call by sending a call control setup message “CC Setup” 766 to the S-MSC/VLR 606 containing information relating to the MSRN.

The S-MSC/VLR 606 sends an ISUP initial address message (IAM) 768 to the GMSC 608. The ISUP IAM message 768 contains the information relating to the MSRN (denoted B=MSRN). Messaging 770 then takes place between the GMSC 608 and the HSS 612 exchanging routing information and to verify the TE.

The GMSC 608 sends a routing information message “Send Routing Info” 772 comprising the mobile subscriber ISDN number for the TE 602 (A_MSISDN) to the HSS 612. The HSS sends a routing information response message “Send Routing Info Response” 774 comprising the IMSI of the TE 602 (denote A=IMSI).

The GMSC 608 can then verify, as denoted by block 776, the IMSI received from the TE 602 with that received from the HSS to verify the TE 602. The GMSC then sends an ISUP inquiry access code (IAC) message “IAC” 680 to the S-MSC/VLR 606.

Once this message is received, call establishment is complete, and the S-MSC/VLR 606 sends a call establishment complete message “Complete” 682 using circuit switched call control to the MT 604.

In both the embodiments illustrated in FIGS. 5 and 6, the call establishment method is circuit switched call control as the messaging between the MT and the S-MSC/VLR (the core network) is done using circuit switched call control. Once the call is established, data is transmitted between the MT and the core network in the radio access network and air interface in the circuit switched domain. Within the core network, the call is handled in the packet switched domain.

Thus as in the first embodiment of FIGS. 3 and 4 a voice call is preferably only established in the CS domain in the air interface, and additionally the voice call is only established using CS techniques.

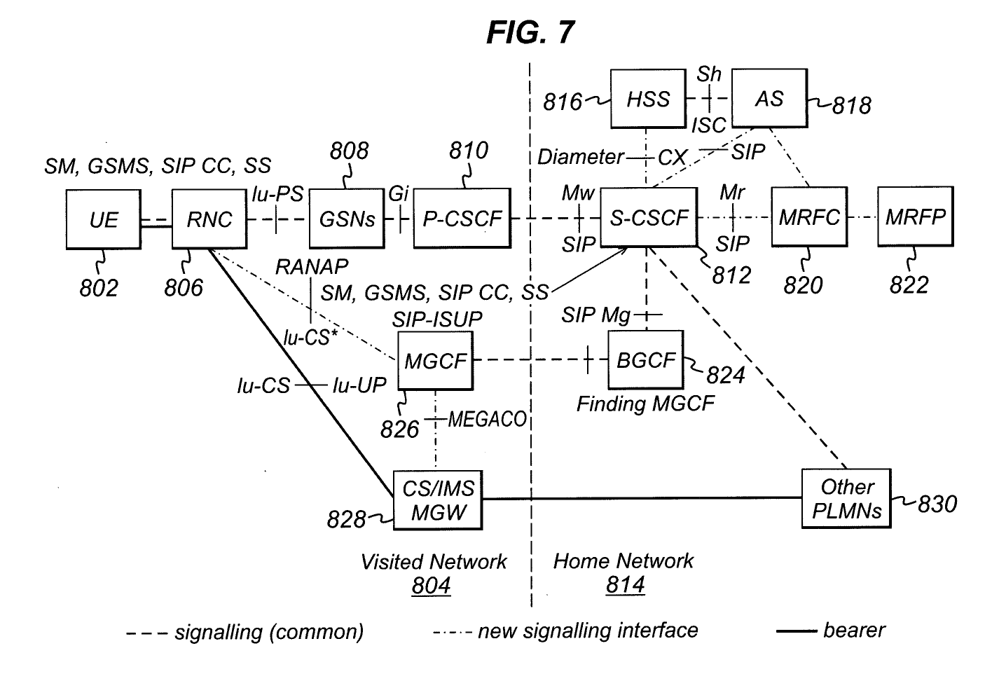

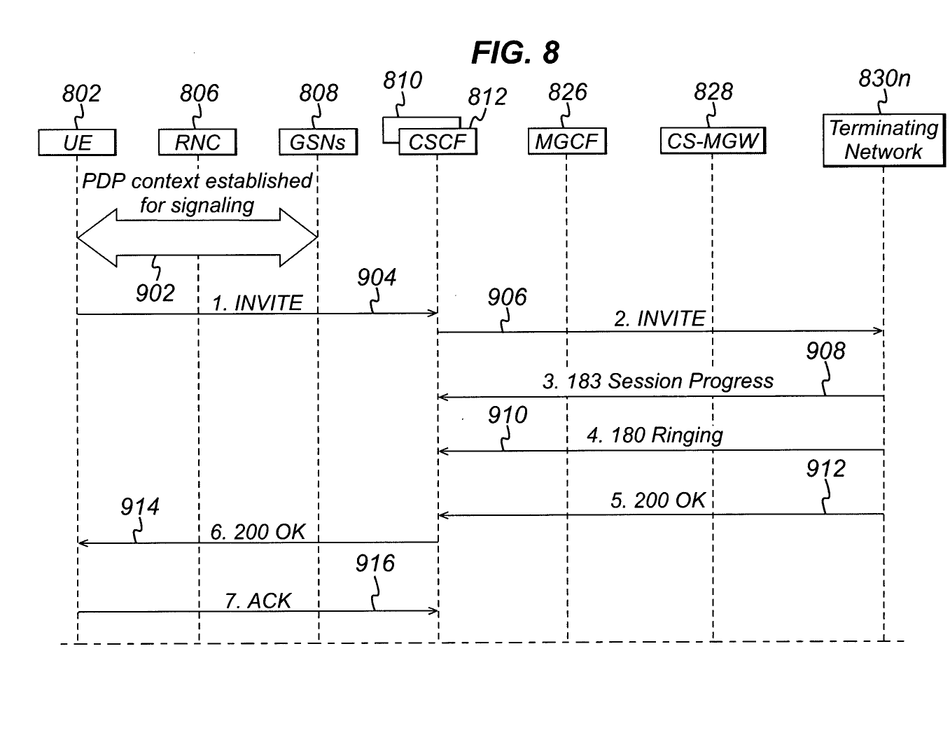

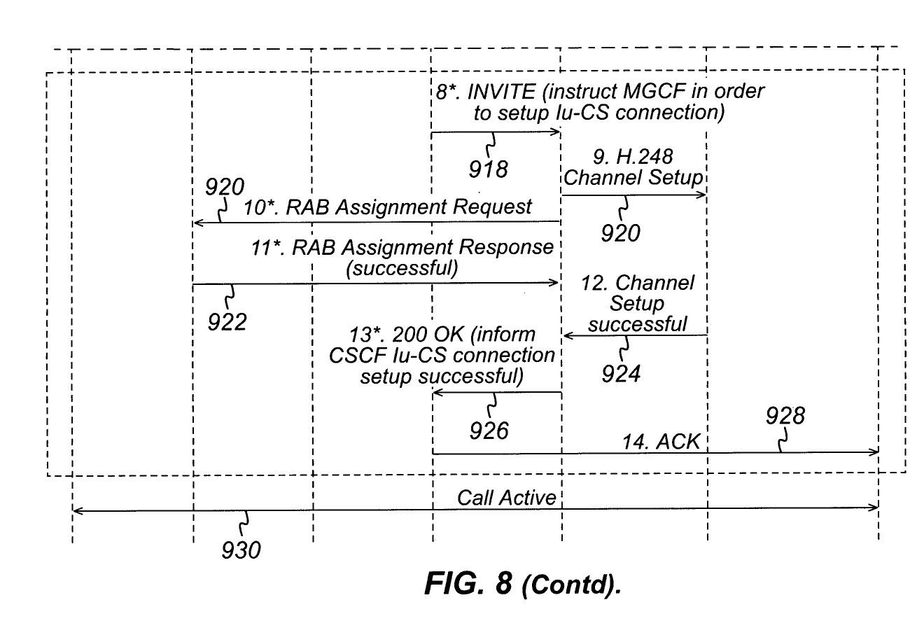

Reference is now made to FIGS. 7 and 8, which illustrate the establishment of a voice call in a third embodiment of the invention.

FIG. 7 illustrates an examplary network architecture for the third embodiment of the invention. In the example of the third embodiment, it is assumed that the user equipment is connected in a visited network. Referring to FIG. 7, a UE 802 is connected in to the visited network 804 via an air interface connection to a radio network controller (RNC) 806. The visited network includes a plurality of GPRS support nodes (GSNs) 808, each of which may include a SGSN and a GGSN (not shown). The RNC 806 connects the UE 802 to a selected one of the GSNs 808 when a call is established.

FIG. 7 shows a proxy call state control function (P-CSCF) 810, which controls the call state of the call to/from the UE 802 in the visited network 804. The P-CSCF 810 therefore connects to the one of the GSNs 808 supporting the call to/from the UE 808. The P-CSCF 810 in the visited network is connected to a serving call state control function (S-CSCF) 812 in a home network 814 with which the UE 802 is normally connected.

In the home network 814, the S-CSCF 812 is connected to a home subscriber server (HSS) 816 and an application server 818. The S-CSCF 812 further connects in the home network 814 to a MRFC 820, which in turn connects to a MRFP 822.

The S-CSCF 812 connects to a breakout gateway control function (BGCF) 824 in the home network, which connects to a media gateway control function (MGCF) 826 in the visited network. In accordance with this third embodiment of the invention, the MGCF 826 further connects to the RNC 806. The MGCF 826 also connects to a circuit switched/IP multimedia sub system media gateway (CS/IMS MGW) 828.

The S-CSCF 812 of the home network further connects to other public land mobile networks (PLMNs) 830, or external networks. The invention is described with reference to an example where a call is established between the UE 402 and a terminal connected to a PLMN 830.

The network illustrated in FIG. 7 is a typical UMTS network arrangement as will be familiar to one skilled in the art. The arrangement is adapted in accordance with this third embodiment of the invention to provide the connection between the RNC 806 and the MGCF 826 as further described hereinbelow.

The PLMN 830 may include the Internet or other communications networks in this embodiment. Various user equipment or terminals may be connected to the PLMN 830 such as mobile terminals, SIP enabled devices and personal computers.

This third embodiment of the invention involves the use of a single call control mechanism, such as a SIP based call control mechanism, to establish both packet switched and circuit switched calls. This embodiment is now further described with reference to the message flow diagram of FIG. 8.

In FIG. 8, for simplicity the message flow is shown as directly to the S-CSCF 812, although in practice it would be via the P-CSCF 810. A terminating network (to which a call is established with the UE 802) is denoted 830n, being one of the PLMNs 830.

The UE attempts to establish a voice call to a party connected in a terminating network 830n. The UE and the visited network 804 establish a PDP context for the voice call as represented by bi-directional signalling 902. This signalling takes place before the establishment of a voice call and may be required to configure the various network elements and establish the data bearer for the voice call. The signalling may be based on SIP signalling and messages. Other suitable protocols may be used such as MEGACO, also known as H.248.

During the bi-directional signalling, the IP address and port number of the CS MGW 828 may be transmitted to the UE. The IP address and port number of the CS MGW 828 may be determined in a discovery procedure similar to existing discovery procedures for determining the IP address and port number of a P-CSCF. The IP address and port number may be used by the terminating network 830n to direct voice data to the appropriate CS MGW, which can then be transmitted to the UE, rather than directly to the UE.

The UE 802 then transmits an SIP INVITE message 904 to the S-CSCF 812. The SIP INVITE message may include the IP address of the CS MGW obtained during the bi-directional signalling. This message may be routed via the P-CSCF 810 or transmitted directly to the S-CSCF 812. Upon receipt of the SIP INVITE message 804, the S-CSCF 812 performs SIP URI (universal resource indicator) address analysis in order to determine the destination of the call to be established.

Once this destination is established, the S-CSCF forwards an SIP INVITE message 906, which includes the IP address of the CS MGW, to the terminating network 830n. The terminating network 830n may be, for example, one of: the same network, another network (PLMN), a PSTN, or the Internet.

As represented by messages 908 and 910, sequential SIP signalling occurs. Specifically, in message 908, the terminating network 830n transmits a SIP 183 Session Progress message to the S-CSCF 812.

The terminating network 830n transmits a SIP 180 Ringing message 910 to the S-CSCF 812, and then transmits the SIP 2000K message 912 to the S-CSCF 812.

Responsive to the SIP 2000K message 912, the S-CSCF 812 returns a SIP 2000K message 914 to the UE 802. The UE 802 acknowledges the SIP 200 OK message 914 by transmitting a SIP ACK message 916 back to the S-CSCF 812.

In response to receiving the SIP ACK message 916, the S-CSCF 812 transmits a SIP INVITE message 918 to the MGCF 826 that controls the RNC 806 serving the UE 802. The SIP INVITE message 918 may provide all the information required by the MGCF 826 for initiating a RAB (radio access bearer) assignment procedure. The RAB assignment procedure is used to establish an Iu circuit switched (lu-CS) connection or data bearer between the RNC 806 and the CS MGW 828 in accordance with this embodiment of the invention.

The MGCF 826 transmits a RAB Assignment Request message 920 to the RNC 806 serving the UE 802 with the appropriate parameters. The RNC 806 responds by transmitting an RAB Assignment Response (Successful) message 922 to the MGCF 826. The response message may also include a RAB identifier and other parameters, such as transport layer information and the cause of failure if the RAB assignment unsuccessful.

Whilst the RAB is being established between the RNC 806 and the CS MGW 828, the CS MGW 828 also establishes a channel between the CS MGW 828 and the terminating network 830n. The MGCF 826 transmits a H.248 Channel Setup message 919 to the CS MGW 828.

H.248 is an ITU-T standard, known as MEGACO under IETF. It is a protocol used between elements of a physically decomposed multimedia gateway e.g. a MGW and a MGCF, for the MGCF to tell the MGW when and how to establish a media channel for a call, and for the MGW to notify the MGCF of the status of the setup.

The CS MGW 828 establishes a channel between the CS MGW and the terminating network 830n and transmits a H.248 Channel Setup Successful message 924 back to the MGCF 826.

Channel establishment is now complete at the CS MGW 828. The MGCF transmits a SIP 2000K message 926 to the S-CSCF 812 informing it of successful data bearer establishment. The S-CSCF 812 then transmits a SIP ACK message 928 to the terminating network 830n to activate the data bearer for the voice call.

The voice call may then take place between the UE 802 and the terminating network 830n. With reference to FIG. 7, the lines joining the UE 802 to the RNC 806, the RNC 806 to the CS MGW 828 and the CS MGW 828 to the other PLMNs 830 represent the data bearer path for the voice call.

In the example of this third embodiment, the voice data is transmitted as a circuit switched encoded datastream for the entire data bearer.

The terminating network may use the IP address and port number of the CS MGW received during call establishment to transmit voice data to the CS MGW, which can then route the voice data onto the UE. Thus, a circuit switched encoded datastream can be maintained for the entire data bearer.

This method is used for both circuit switched and packet switched based calls. There is no requirement for conversion, other than at the boundary between the PLMN and Internet, in case one end is a SIP device on the Internet, then circuit switched to packet switched VoIP conversion is needed.

Three embodiments have thus been described for establishing—in preferred arrangements—a voice call in the circuit switched domain over the air interface, even when the call is routed in the packet switched domain in the core network. The first embodiment utilises SIP signalling to achieve this, the second embodiment utilises circuit switched call control to achieve this, and the third embodiment utilises SIP to establish all calls in the circuit switched domain. Thus the same control mechanism is used whether the core network carries the call in the circuit or packet switched domains.

In the implementation of the third embodiment, session initiation protocol (SIP) is used as the call control method for both circuit switched and packet switched voice calls. The data bearers for the voice call are entirely in the circuit switched domain. The technique of this embodiment may be used in order for SIP to replace the GSM call control mechanism for a circuit switched call. Thus only one call control method is required for both circuit switched and packet switched calls.

The above described methods result in several advantages over prior art methods.

When SIP signalling is used as the call control mechanism to establish all voice calls, any suitably configured SIP device such as a mobile terminal or a laptop can readily make voice calls. Furthermore, the voice calls are also more efficient in their use of network resources than previous VoIP calls, as the existing circuit switched air interface is utilised in the transmission of the voice call without the need for packet switched overheads such as data packet headers. It is advantageous to reduce the data transmission over the air interface whenever possible due to capacity and cost restrictions of data transmission over the air interface. This may also increase capacity in the network and promote faster adoption of VoIP.

Furthermore, the methods described above in embodiments do not require any compression or header removal techniques that have previously been suggested to reduce the data that needs to be transmitted over the air interface in a PS datastream. This makes the methods simpler to implement and cheaper to operate.

By replacing previously separate circuit switched and packet switched call control mechanisms with a single mechanism such as one based on SIP described above, the call control protocol stacks that need to be employed in the UE may also be reduced, thus saving development costs and memory at the UE.

Another significant advantage is that if both circuit switched and packet switched voice calls are handled in the manner as VoIP calls, then it may be possible to remove the MSC server present in existing circuit switched networks and save costs.

Herein reference is made to the packet switched domain and the circuit switched domain. More generally, reference can be made to a first domain and a second domain, each of which domain carries or transports a respective first and second type of datastream. The first and second domains may alternatively be referred to as first and second transport platforms or transport mechanisms, being respective platforms or mechanisms for first and second datastreams.

It is also noted herein that while the above describes exemplifying embodiments of the invention, there are several variations and modifications which may be made to the described embodiments without departing from the scope of the present invention as defined in the appended claims. One skilled in the art will recognise modifications to the described embodiments.

1. A method of establishing a communication in a mobile communication system comprising a core network and at least one user equipment connected thereto via a radio access network, the method comprising:
providing at least two types of domain for carrying a predetermined datastream for a communication in a core network; and
providing one of said at least two types of domain for carrying the predetermined datastream in a radio access network.

2. A method according to claim 1, wherein said providing comprises providing the at least two types of domain for carrying the predetermined datastream, wherein the communication comprises a voice call and the predetermined datastream comprises voice data.

3. A method according to claim 2, wherein said providing comprises providing the at least two types of domain for carrying the predetermined datastream, wherein the at least two type of domains include a packet switched domain and a circuit switched domain, and wherein the circuit switched domain is provided in the radio access network.

4. A method according to claim 3, further comprising connecting a user equipment to the radio access network via an air interface, and the circuit switched domain provided in the radio access network is provided over the air interface.

5. A method according to claim 3, further comprising establishing the voice call using first and second call establishment methods for each of the packet and circuit switched domains.

6. A method according to claim 5, wherein said establishing comprises establishing the voice call using the first call establishment method, wherein_the first call establishment method for the packet switched domain comprises a SIP based method.

7. A method according to claim 6, further comprising using the SIP based method to establish a PDP context.

8. A method according to claim 7, further comprising initiating the PDP context between a control element of the packet switched domain and a gateway element of the circuit switched domain.

9. A method according to claim 8, wherein said initiating comprises initiating the PDP context in the packet switched domain after an initial PDP context establishment for the voice call.

10. A method according to claim 8, wherein said initiating comprises initiating the PDP context between the control element and the gateway element, wherein the gateway element establishes a data bearer for the voice call.

11. A method according to claim 5, wherein said establishing comprises establishing the voice call using the second establishment method, and wherein the second call establishment method for the circuit switched domain comprises a circuit switched call control method.

12. A method according to claim 8, wherein said initiating comprises initiating the PDP context between the control element and the gateway element, wherein the gateway element comprises a circuit switched media gateway.

13. A method according to claim 4, further comprising establishing the voice call using a single call establishment method for each of the packet and circuit switched domains.

14. A method according to claim 13, wherein said establishing comprises establishing the voice call using the single call establishment method, wherein the single call establishment method comprises a circuit switched call control method.

15. A method according to claim 4, further comprising carrying the voice data in the circuit switched domain in the core network.

16. A method according to claim 15, further comprising establishing the voice call using a single call establishment method for each of the packet and circuit switched domains.

17. A method according to claim 16, wherein said establishing comprises establishing the voice call using the single call establishment method, wherein the call establishment method comprises a SIP based method.

18. A method according to claim 16, further comprising carrying the voice data in a circuit switched datastream over the radio access network and the core network.

19. The method according to claim 15, further comprising providing an interface to the core network to convert a circuit switched datastream if the circuit switched datastream for the voice data terminates at a packet switch enabled device.

20. A method according to claim 18, wherein said carrying comprises carrying the voice data in the circuit switched datastream, wherein the circuit switched datastream passes through a gateway element.

21. A method according to claim 20, wherein said carrying comprises carrying the voice data in the circuit switched datastream, wherein the circuit switched datastream passes through the gateway element, the gateway element comprises a circuit switched media gateway.

22. A method according to claim 1, further comprising providing a user equipment connected to the radio access network, wherein the user equipment comprises a mobile terminal.

23. A mobile communication system comprising a core network and at least one user equipment connected thereto via a radio access network, the mobile communication system comprising:
means for providing at least two types of domain configured for carrying a predetermined datastream for a communication in a core network; and
means for providing one of said at least two types of domain for carrying the predetermined datastream in a radio access network.

24. A mobile communication system according to claim 23, wherein the communication comprises a voice call and the predetermined datastream comprises voice data.

25. A mobile communication system according to claim 24, wherein the at least two type of domains include a packet switched domain and a circuit switched domain, and wherein the circuit switched domain is provided in the radio access network.

26. A mobile communication system according to claim 25, wherein a user equipment is connected to the radio access network via an air interface, and the circuit switched domain provided in the radio access network is provided over the air interface.

27. A mobile communication system according to claim 25, further comprising means for establishing the voice call using first and second call establishment methods for each of the packet and circuit switched domains.

28. A mobile communication system according to claim 25, further comprising means for establishing the voice call using a single call establishment method for each of the packet and circuit switched domains.

29. A mobile communication system according to claim 25, further comprising means for carrying the voice data in the circuit switched domain in the core network.

30. A mobile communication system according to claim 29, further comprising means for establishing the voice call using a single call establishment method for each of the packet and circuit switched domains.

31. A network element for a mobile communication system, wherein said mobile communication system comprises a core network and at least one user equipment connected thereto via a radio access network and at least a packet switched domain and a circuit switched domain for carrying a predetermined datastream for a voice call in the core network, said network element configured for providing the circuit switched domain for carrying the predetermined datastream in the radio access network.
